(19) United States
(12) Patent Application Publication
(10) Pub. No.: US 2026/0297761 A1
(43) Pub. Date: Oct. 1, 2026

(54) HYDROGEN-ELECTRIC COUPLING CONTROL SYSTEM AND METHD FOR OFF-GRID GREEN POWER-BASED HYDROGEN PRODUCTION

(71) Applicants: State Grid Jiangsu Electric Power Co., Ltd. Research Institute, Nanjing (CN); Jiangsu Electric Powe Research Institute Co., Ltd., Shenyang (CN); State Grid Jiangsu Electric Power Co., Ltd., Nanjing (CN)

(72) Inventors: Xinda WANG, Nanjing (CN); Rui ZHU, Nanjing (CN); Xing ZHANG, Nanjing (CN); Qunyan DING, Nanjing (CN)

(73) Assignees: State Grid Jiangsu Electric Power Co., Ltd. Research Institute, Nanjing (CN); Jiangsu Electric Powe Research Institute Co., Ltd., Shenyang (CN); State Grid Jiangsu Electric Power Co., Ltd., Nanjing (CN)

(21) Appl. No.: 19/405,472

(22) Filed: Dec. 2, 2025

Related U.S. Application Data
(63) Continuation of application No. PCT/CN2025/134601, filed on Nov. 13, 2025.

(30) Foreign Application Priority Data
Mar. 28, 2025 (CN) 202510380156.5

(51) Int. Cl. C25B 1/04; H02J 1/00; H02J 101/24; H02S 10/00

(52) U.S. Cl. CPC C25B 1/04; H02J 1/00; H02S 10/00; H02J 2101/25

(57) ABSTRACT

A hydrogen-electric coupling control method for off-grid green power-based hydrogen production includes: performing maximum power point tracking (MPPT) control on each photovoltaic module to maximize an output power; distributing the output power to a power-type electrolyzer, and stabilizing a current on a low-voltage side at a specified value by adjusting a duty cycle of a boost direct current (DC)/DC converter, such that the power-type electrolyzer always operates at a rated power point; and distributing the output power to a regulation-type electrolyzer, and stabilizing a voltage on a high-voltage side at a target value by adjusting an output voltage of the boost DC/DC converter, such that the regulation-type electrolyzer absorbs a fluctuating part of a photovoltaic power. The hydrogen-electric coupling control method can effectively improve efficiency of a green power-based hydrogen production system, and realize stable and sustainable hydrogen production without relying on energy storage.

### CROSS REFERENCE TO THE RELATED APPLICATIONS

This application is the continuation application of International Application No. PCT/CN2025/134601, filed on Nov. 13, 2025, which is based upon and claims priority to Chinese Patent Application No. 202510380156.5, filed on Mar. 28, 2025, the entire contents of which are incorporated herein by reference.

### TECHNICAL FIELD

The present disclosure relates to a hydrogen-electric coupling control system and method for off-grid green power-based hydrogen production, and belongs to the technical field of green power-based hydrogen production.

### BACKGROUND

With the continuous large-scale connection of new energy, the problem of source-load imbalance has become increasingly prominent. As an effective solution to the problem, green power-based hydrogen production has achieved rapid development in recent years. There are two green power-based hydrogen production modes: off-grid green power-based hydrogen production and grid-connected green power-based hydrogen production. Although traditional grid-connected hydrogen production uses a power grid as a power source, it cannot ensure that electricity is completely derived from green energy and fails to obtain a green electricity certificate. Therefore, it is unable to sell hydrogen and its derivatives in the international market.

In contrast, off-grid hydrogen production has a more simplified structure, and usually adopts an all-direct current (DC) system to reduce alternating current (AC)-DC conversion, thereby improving the overall efficiency of the system. In scenarios lacking conditions for grid connection with a strong power grid, such as new energy bases in deserts or barren regions, the off-grid green power-based hydrogen production is particularly advantageous. With the large-scale connection of new energy, the off-grid green power-based hydrogen production will be more widely applied in the future. However, to achieve this goal, a plurality of technical bottlenecks still need to be broken through, especially in terms of improving system efficiency, stability, and sustainability.

### SUMMARY

An objective of the present disclosure is to overcome the deficiencies in the prior art and provide a hydrogen-electric coupling control system and method for off-grid green power-based hydrogen production. An operating state of an electrolyzer is improved, so as to improve hydrogen production efficiency and solve a problem that an electrolyzer in an existing green power-based hydrogen production system fails to operate at an optimal efficiency point.

In order to achieve the above objective, the present disclosure adopts the following technical solutions:

According to a first aspect, the present disclosure provides a hydrogen-electric coupling control system for off-grid green power-based hydrogen production, including:
a plurality of photovoltaic modules, where each of the plurality of photovoltaic modules is connected to an electrolyzer through a boost DC/DC converter and maximizes an output power through maximum power point tracking (MPPT) control;
a plurality of electrolyzers including a power-type electrolyzer and a regulation-type electrolyzer; and
a power distribution unit, including:
a power-type electrolyzer control module configured to distribute the output power to the power-type electrolyzer, and stabilize a current on a low-voltage side at a specified value by adjusting a duty cycle of the boost DC/DC converter, such that the power-type electrolyzer always operates at a rated power point; and
a regulation-type electrolyzer control module configured to distribute the output power to the regulation-type electrolyzer, and stabilize a voltage on a high-voltage side at a target value by adjusting an output voltage of the boost DC/DC converter, such that the regulation-type electrolyzer absorbs a fluctuating part of a photovoltaic power.

Further, the MPPT control is implemented based on a perturbation and observation method or an incremental conductance method.

Further, the rated power point of the power-type electrolyzer is determined based on an electrolyzer efficiency-current characteristic curve, and the specified value of the current on the low-voltage side is dynamically configured based on an optimal efficiency point of the curve.

Further, an input power range of the regulation-type electrolyzer covers a maximum fluctuation amplitude of a photovoltaic output power, and the target value of the voltage on the high-voltage side of the regulation-type electrolyzer is dynamically adjusted based on a real-time power balance requirement of the system.

Further, the power distribution unit is further configured to dynamically distribute a ratio of a quantity of power-type electrolyzers to a quantity of regulation-type electrolyzers based on a real-time change in a photovoltaic output power.

Further, the electrolyzers further include standby electrolyzers, and when the photovoltaic power exceeds a regulation capacity of the regulation-type electrolyzer, system stability is maintained by starting or stopping some of the standby electrolyzers or switching an electrolyzer operation mode, and the electrolyzer operation mode includes a power type and a regulation type.

Further, the MPPT control, constant current control of the power-type electrolyzer and constant voltage control of the regulation-type electrolyzer are implemented through independent closed loops, and the MPPT control, the constant current control of the power-type electrolyzer and the constant voltage control of the regulation-type electrolyzer operate collaboratively through bus communication or a central controller.

Further, control logic of the boost DC/DC converter is bound to an electrolyzer type, where the power-type electrolyzer corresponds to a closed loop of the current on the low-voltage side, and the regulation-type electrolyzer corresponds to a closed loop of the voltage on the high-voltage side.

Further, output powers of the plurality of photovoltaic modules are controlled through a plurality of boost DC/DC converters.

According to a second aspect, the present disclosure provides a control method for the hydrogen-electric coupling control system for off-grid green power-based hydrogen production according to any of the preceding embodiments, including:
performing MPPT control on each photovoltaic module to maximize an output power;
distributing the output power to the power-type electrolyzer, and stabilizing the current on the low-voltage side at the specified value by adjusting the duty cycle of the boost DC/DC converter, such that the power-type electrolyzer always operates at the rated power point; and
distributing the output power to the regulation-type electrolyzer, and stabilizing the voltage on the high-voltage side at the target value by adjusting the output voltage of the boost DC/DC converter, such that the regulation-type electrolyzer absorbs the fluctuating part of the photovoltaic power.

Further, the MPPT control is implemented based on the perturbation and observation method or the incremental conductance method.

Further, the rated power point of the power-type electrolyzer is determined based on the electrolyzer efficiency-current characteristic curve, and the specified value of the current on the low-voltage side is dynamically configured based on the optimal efficiency point of the curve.

Further, the input power range of the regulation-type electrolyzer covers the maximum fluctuation amplitude of a photovoltaic output power, and the target value of the voltage on the high-voltage side of the regulation-type electrolyzer is dynamically adjusted based on a real-time power balance requirement of the system.

Further, the control method further includes: dynamically distributing the ratio of a quantity of power-type electrolyzers to a quantity of regulation-type electrolyzers based on a real-time change in a photovoltaic output power.

Further, the control method further includes: when the photovoltaic power exceeds the regulation capacity of the regulation-type electrolyzer, maintaining system stability by starting or stopping some standby electrolyzers or switching an electrolyzer operation mode, where the electrolyzer operation mode includes a power type and a regulation type.

Further, the control method further includes: implementing the MPPT control, constant current control of the power-type electrolyzer and constant voltage control of the regulation-type electrolyzer through independent closed loops, where the MPPT control, the constant current control of the power-type electrolyzer and the constant voltage control of the regulation-type electrolyzer operate collaboratively through bus communication or a central controller.

Further, the control method further includes: binding control logic of the boost DC/DC converter to an electrolyzer type, where the power-type electrolyzer corresponds to a closed loop of the current on the low-voltage side, and the regulation-type electrolyzer corresponds to a closed loop of the voltage on the high-voltage side.

Further, the control method further includes: controlling output powers of the plurality of photovoltaic modules through a plurality of boost DC/DC converters.

Compared with the prior art, the present disclosure has the following beneficial effects.

The present disclosure provides a hydrogen-electric coupling control system and method for off-grid green power-based hydrogen production. Electrolyzers are classified into a power-type electrolyzer and a regulation-type electrolyzer, and power distribution is optimized. In this way, the power-type electrolyzer always operates at a maximum efficiency point, while the regulation-type electrolyzer takes on a fluctuating part of a photovoltaic power and performs a function of energy storage, thereby ensuring system voltage stability and improving hydrogen production efficiency. The system is independent of an energy storage device. Through reasonable power distribution and control strategies, a stable hydrogen production process can still be achieved when the photovoltaic power fluctuates. The present disclosure is applicable to a multi-photovoltaic multi-electrolyzer hydrogen production system, featuring advantages such as significantly improving efficiency, reducing a loss, and ensuring system stability, and thus possesses high practical value and economic benefits.

### BRIEF DESCRIPTION OF THE DRAWINGS

FIG. 1 is a topological diagram of multi-electrolyzer hydrogen production;

FIG. 2 is a topological diagram of multi-photovoltaic multi-electrolyzer hydrogen production;

FIGS. 3A-3C are distribution diagrams of a fluctuating power of new energy;

FIG. 4 shows operation efficiency of an electrolyzer;

FIG. 5 is a control block diagram of a power-type electrolyzer; and

FIG. 6 is a control block diagram of a regulation-type electrolyzer.

### DETAILED DESCRIPTION OF THE EMBODIMENTS

The present disclosure is further described below with reference to the accompanying drawings. The following embodiments are only used for describing the technical solutions of the present disclosure more clearly, and are not intended to limit the protection scope of the present disclosure.

In Embodiment 1, a hydrogen-electric coupling control system for off-grid green power-based hydrogen production is described, including:
a plurality of photovoltaic modules, where each of the plurality of photovoltaic modules is connected to an electrolyzer through a boost DC/DC converter and maximizes an output power through MPPT control;
a plurality of electrolyzers including a power-type electrolyzer and a regulation-type electrolyzer; and
a power distribution unit, including:
a power-type electrolyzer control module configured to distribute the output power to the power-type electrolyzer, and stabilize a current on a low-voltage side at a specified value by adjusting a duty cycle of the boost DC/DC converter, such that the power-type electrolyzer always operates at a rated power point; and
a regulation-type electrolyzer control module configured to distribute the output power to the regulation-type electrolyzer, and stabilize a voltage on a high-voltage side at a target value by adjusting an output voltage of the boost DC/DC converter, such that the regulation-type electrolyzer absorbs a fluctuating part of a photovoltaic power.

With reference to a preferred embodiment, the following describes content involved in the above embodiment.

In an existing green power-based hydrogen production system, a source side adopts the boost DC/DC converter and performs the MPPT control to ensure that a photovoltaic output voltage is maintained at an optimal power point. The DC-DC converter on a load side dynamically adjusts a load power based on a change in a photovoltaic output power by controlling the voltage (U_{H}) at the high-voltage side, thereby achieving energy balance of the system. Under a condition of stable hydrogen production, this control scheme can maximize utilization of photovoltaic energy, while realizing high-voltage power transmission and reducing an energy transmission loss. However, although the existing system can achieve a maximum output power at a photovoltaic end, the electrolyzer usually does not operate at an optimal efficiency point.

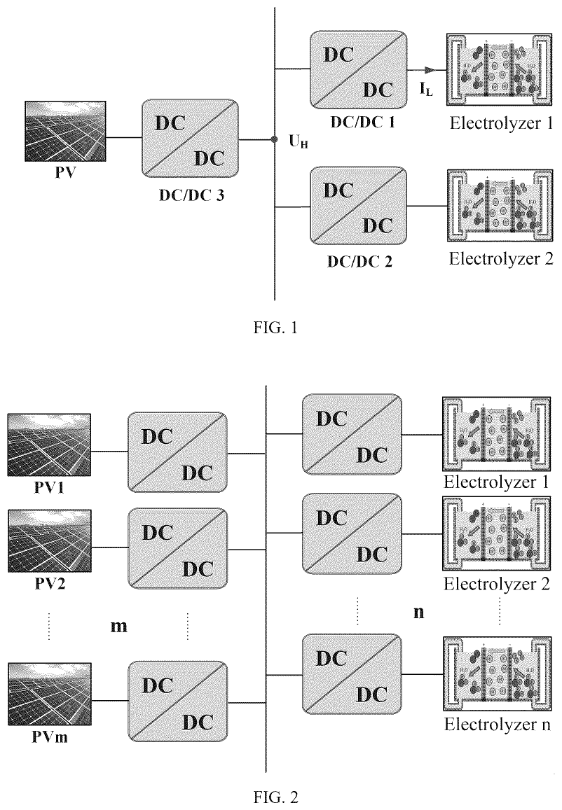

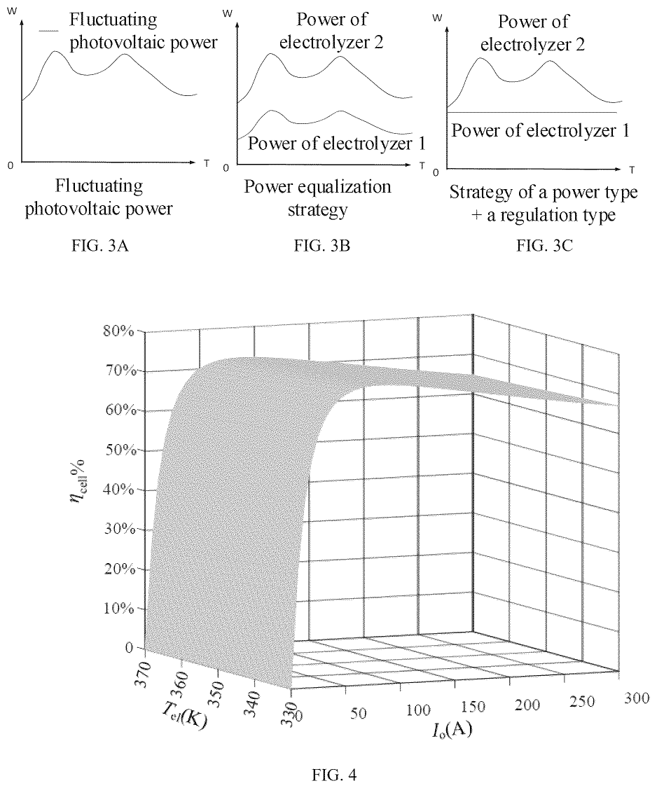

To solve the above problem, the present disclosure provides a multi-electrolyzer hydrogen production model, which is suitable for a scenario with a large fluctuation in an output power of a photovoltaic system. A typical topological structure of the model is shown in FIG. 1. An actual photovoltaic output has a power fluctuation (as shown in FIG. 3A). An existing scheme uniformly distributes the photovoltaic output power to two electrolyzers (as shown in FIG. 3B), and the two electrolyzers jointly take on a photovoltaic power fluctuation. An advantage of this scheme is that a control strategy is simple and easy to implement, and stable operation of the system can be achieved by adding droop control to a DC/DC control strategy on the load side. However, in this case, the two electrolyzers fail to operate at the optimal efficiency point, resulting in low operating efficiency of the electrolyzers. Especially in the case of a low power (current), efficiency of the electrolyzers decreases significantly (as shown in FIG. 4).

In this embodiment, the electrolyzers are classified into the power-type electrolyzer and the regulation-type electrolyzer. The power-type electrolyzer is always maintained at the optimal efficiency point (usually at the rated power point), while the regulation-type electrolyzer is configured to balance a fluctuating part of the photovoltaic energy (as shown in FIG. 3C).

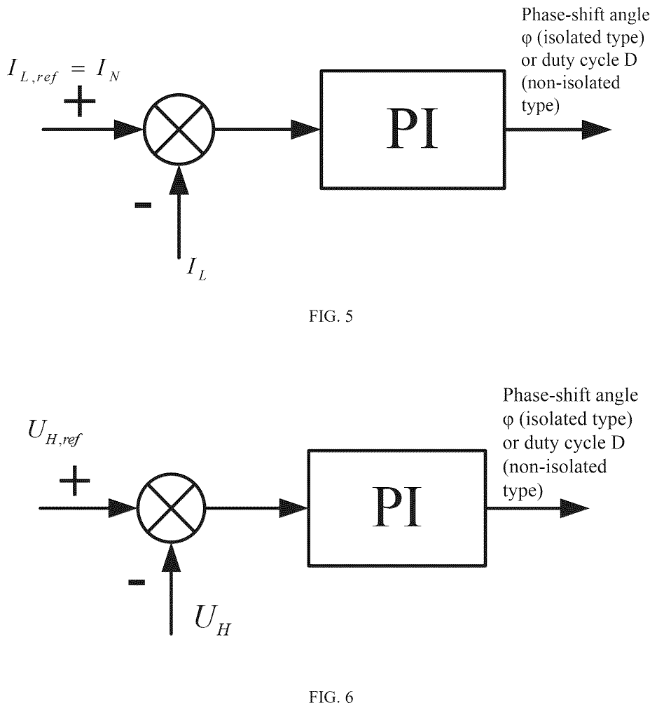

In this scheme, to ensure that the power-type electrolyzer always operates at the optimal efficiency point, a constant current control strategy on the low-voltage side needs to be adopted for DC/DC1 to keep the current I_{L} on the low-voltage side constant. A block diagram of this control strategy is shown in FIG. 5. Under a constant temperature, the power-type electrolyzer behaves as a constant power load. The regulation-type electrolyzer is responsible for taking on the photovoltaic power fluctuation, and a constant voltage U_{H} control strategy on the high-voltage side is adopted for DC/DC2, as shown in FIG. 6.

In this scheme, a photovoltaic power source provides a maximum power. The power-type electrolyzer operates at a constant power, and a remaining fluctuating power is taken on by the regulation-type electrolyzer. The regulation-type electrolyzer plays a role in maintaining system voltage stability, and under its voltage regulation effect, ensures that MPPT of the photovoltaic module and current control of the power-type electrolyzer on the low-voltage side are stabilized. As a balance node of the system, the regulation-type electrolyzer is crucial to system stability.

The scheme in this embodiment does not require energy storage configuration, and when the stable hydrogen production is achieved, can ensure the MPPT control of the photovoltaic module and the high-voltage power transmission and enable some loads to operate at the optimal efficiency point. The promotion of the model can be further applied to an actual multi-photovoltaic and multi-electrolyzer photovoltaic hydrogen production system, and a specific topological structure is shown in FIG. 2.

Assuming that in the multi-photovoltaic and multi-electrolyzer hydrogen production system shown in FIG. 2, m photovoltaic modules are connected to a source side, and a DC/DC converter of each photovoltaic module adopts the MPPT control. There are n electrolyzers disposed on a load side, and these electrolyzers can be classified into three categories: standby electrolyzers, power-type electrolyzers, and regulation-type electrolyzers.

In this system, when a quantity of power-type electrolyzers is close to a total quantity of operating electrolyzers, high hydrogen production efficiency is achieved, but regulation performance of the system is poor. In an extreme case, a power shortage may exceed a maximum regulation capacity of the regulation-type electrolyzer, resulting in an unstable system voltage and ultimately system instability. Conversely, when the quantity of power-type electrolyzers is small, the regulation performance of the system is strong, but low hydrogen production efficiency is caused.

Therefore, it is necessary to increase a quantity of regulation-type electrolyzers. The quantity of regulation-type electrolyzers is closely related to photovoltaic output prediction accuracy and an electrolyzer startup/stop speed. More accurate prediction of the photovoltaic output power or faster electrolyzer startup/stop and regulation lead to fewer regulation-type electrolyzers required and more operating electrolyzers that can be used as power-type electrolyzers. Conversely, there are more regulation-type electrolyzers required and fewer operating electrolyzers that can be used as power-type electrolyzers. In an extreme case, the system consists of only regulation-type electrolyzers, degenerating into a fluctuating power equalization mode.

In Embodiment 2, a control method for the hydrogen-electric coupling control system for off-grid green power-based hydrogen production in Embodiment 1 is provided, including the following steps:
MPPT control is performed on each photovoltaic module to maximize an output power.
The output power is distributed to the power-type electrolyzer, and the current on the low-voltage side is stabilized at the specified value by adjusting the duty cycle of the boost DC/DC converter, such that the power-type electrolyzer always operates at the rated power point.
The output power is distributed to the regulation-type electrolyzer, and the voltage on the high-voltage side is stabilized at the target value by adjusting the output voltage of the boost DC/DC converter, such that the regulation-type electrolyzer absorbs the fluctuating part of the photovoltaic power.
The MPPT control is implemented based on the perturbation and observation method or the incremental conductance method.
The rated power point of the power-type electrolyzer is determined based on the electrolyzer efficiency-current characteristic curve, and the specified value of the current on the low-voltage side is dynamically configured based on the optimal efficiency point of the curve.
The input power range of the regulation-type electrolyzer covers the maximum fluctuation amplitude of the photovoltaic output power, and the target value of the voltage on the high-voltage side of the regulation-type electrolyzer is dynamically adjusted based on a real-time power balance requirement of the system.

The control method further includes: the ratio of a quantity of power-type electrolyzers to a quantity of regulation-type electrolyzers is dynamically distributed based on a real-time change in a photovoltaic output power.

The control method further includes: when the photovoltaic power exceeds a regulation capacity of the regulation-type electrolyzer, system stability is maintained by starting or stopping some standby electrolyzers or switching an electrolyzer operation mode, where the electrolyzer operation mode includes a power type and a regulation type.

The control method further includes: the MPPT control, constant current control of the power-type electrolyzer and constant voltage control of the regulation-type electrolyzer are implemented through independent closed loops, where the MPPT control, the constant current control of the power-type electrolyzer and the constant voltage control of the regulation-type electrolyzer operate collaboratively through bus communication or a central controller.

The control method further includes: control logic of the boost DC/DC converter is bound to an electrolyzer type, where the power-type electrolyzer corresponds to a closed loop of the current on the low-voltage side, and the regulation-type electrolyzer corresponds to a closed loop of the voltage on the high-voltage side.

The control method further includes: output powers of the plurality of photovoltaic modules are controlled through a plurality of boost DC/DC converters.

Through the above optimization method, this embodiment can effectively improve efficiency of a green power-based hydrogen production system and achieve stable and sustainable hydrogen production without relying on energy storage.

The above described are preferred implementations of the present disclosure, and it should be noted that for those of ordinary skill in the art, various improvements and modifications may be made without departing from the principles of the present disclosure. These improvements and modifications should be regarded as falling within the protection scope of the present disclosure.

1. A hydrogen-electric coupling control system for off-grid green power-based hydrogen production, comprising:
a plurality of photovoltaic modules, wherein each of the plurality of photovoltaic modules is connected to an electrolyzer through a boost direct current (DC)/DC converter and maximizes an output power through maximum power point tracking (MPPT) control;
a plurality of electrolyzers comprising a power-type electrolyzer and a regulation-type electrolyzer; and
a power distribution unit, comprising:
a power-type electrolyzer control module configured to distribute the output power to the power-type electrolyzer, and stabilize a current on a low-voltage side at a specified value by adjusting a duty cycle of the boost DC/DC converter, such that the power-type electrolyzer always operates at a rated power point; and
a regulation-type electrolyzer control module configured to distribute the output power to the regulation-type electrolyzer, and stabilize a voltage on a high-voltage side at a target value by adjusting an output voltage of the boost DC/DC converter, such that the regulation-type electrolyzer absorbs a fluctuating part of a photovoltaic out power.

2. The hydrogen-electric coupling control system for off-grid green power-based hydrogen production according to claim 1, wherein the MPPT control is implemented based on a perturbation and observation method or an incremental conductance method.

3. The hydrogen-electric coupling control system for off-grid green power-based hydrogen production according to claim 1, wherein the rated power point of the power-type electrolyzer is determined based on an electrolyzer efficiency-current characteristic curve, and the specified value of the current on the low-voltage side is dynamically configured based on an optimal efficiency point of the electrolyzer efficiency-current characteristic curve.

4. The hydrogen-electric coupling control system for off-grid green power-based hydrogen production according to claim 1, wherein an input power range of the regulation-type electrolyzer covers a maximum fluctuation amplitude of the photovoltaic output power, and the target value of the voltage on the high-voltage side of the regulation-type electrolyzer is dynamically adjusted based on a real-time power balance requirement of the hydrogen-electric coupling control system.

5. The hydrogen-electric coupling control system for off-grid green power-based hydrogen production according to claim 1, wherein the power distribution unit is further configured to dynamically distribute a ratio of a quantity of power-type electrolyzers to a quantity of regulation-type electrolyzers based on a real-time change in the photovoltaic output power.

6. The hydrogen-electric coupling control system for off-grid green power-based hydrogen production according to claim 1, wherein the electrolyzers further comprise standby electrolyzers, wherein when the photovoltaic out power exceeds a regulation capacity of the regulation-type electrolyzer, system stability is maintained by starting or stopping some of the standby electrolyzers or switching an electrolyzer operation mode, wherein the electrolyzer operation mode comprises a power type and a regulation type.

7. The hydrogen-electric coupling control system for off-grid green power-based hydrogen production according to claim 1, wherein the MPPT control, constant current control of the power-type electrolyzer and constant voltage control of the regulation-type electrolyzer are implemented through independent closed loops, and the MPPT control, the constant current control of the power-type electrolyzer and the constant voltage control of the regulation-type electrolyzer operate collaboratively through bus communication or a central controller.

8. The hydrogen-electric coupling control system for off-grid green power-based hydrogen production according to claim 1, wherein control logic of the boost DC/DC converter is bound to an electrolyzer type, wherein the power-type electrolyzer corresponds to a closed loop of the current on the low-voltage side, and the regulation-type electrolyzer corresponds to a closed loop of the voltage on the high-voltage side.

9. The hydrogen-electric coupling control system for off-grid green power-based hydrogen production according to claim 1, wherein output powers of the plurality of photovoltaic modules are controlled through a plurality of boost DC/DC converters.

10. A control method for the hydrogen-electric coupling control system for off-grid green power-based hydrogen production according to claim 1, comprising:
performing the MPPT control on each of the plurality of photovoltaic modules to maximize the output power;
distributing the output power to the power-type electrolyzer, and stabilizing the current on the low-voltage side at the specified value by adjusting the duty cycle of the boost DC/DC converter, such that the power-type electrolyzer always operates at the rated power point; and
distributing the output power to the regulation-type electrolyzer, and stabilizing the voltage on the high-voltage side at the target value by adjusting the output voltage of the boost DC/DC converter, such that the regulation-type electrolyzer absorbs the fluctuating part of the photovoltaic out power.

11. The control method according to claim 10, wherein the MPPT control is implemented based on a perturbation and observation method or an incremental conductance method.

12. The control method according to claim 10, wherein the rated power point of the power-type electrolyzer is determined based on an electrolyzer efficiency-current characteristic curve, and the specified value of the current on the low-voltage side is dynamically configured based on an optimal efficiency point of the electrolyzer efficiency-current characteristic curve.

13. The control method according to claim 10, wherein an input power range of the regulation-type electrolyzer covers a maximum fluctuation amplitude of the photovoltaic output power, and the target value of the voltage on the high-voltage side of the regulation-type electrolyzer is dynamically adjusted based on a real-time power balance requirement of the hydrogen-electric coupling control system.

14. The control method according to claim 10, further comprising: dynamically distributing a ratio of a quantity of power-type electrolyzers to a quantity of regulation-type electrolyzers based on a real-time change in the photovoltaic output power.

15. The control method according to claim 10, further comprising: when the photovoltaic out power exceeds a regulation capacity of the regulation-type electrolyzer, maintaining system stability by starting or stopping some of standby electrolyzers or switching an electrolyzer operation mode, wherein the electrolyzer operation mode comprises a power type and a regulation type.

16. The control method according to claim 10, further comprising: implementing the MPPT control, constant current control of the power-type electrolyzer and constant voltage control of the regulation-type electrolyzer through independent closed loops, wherein the MPPT control, the constant current control of the power-type electrolyzer and the constant voltage control of the regulation-type electrolyzer operate collaboratively through bus communication or a central controller.

17. The control method according to claim 10, further comprising: binding control logic of the boost DC/DC converter to an electrolyzer type, wherein the power-type electrolyzer corresponds to a closed loop of the current on the low-voltage side, and the regulation-type electrolyzer corresponds to a closed loop of the voltage on the high-voltage side.

18. The control method according to claim 10, further comprising: controlling output powers of the plurality of photovoltaic modules through a plurality of boost DC/DC converters.
